(19) United States
(12) Patent Application Publication
(10) Pub. No.: US 2007/0235896 A1
(43) Pub. Date: Oct. 11, 2007

(54) High shrink high modulus biaxially oriented films

(75) Inventors: Michael A. McLeod, Kemah, TX (US); David Smith, LaPorte, TX (US)

Correspondence Address: FINA TECHNOLOGY INC, PO BOX 674412, HOUSTON, TX, 77267-4412, US

(73) Assignee: Fina Technology, Inc.

(21) Appl. No.: 11/399,008

(22) Filed: Apr. 6, 2006

(51) Int. Cl. B29C 55/14

(52) U.S. Cl. 264/210.7; 526/348.1; 526/351

(57) ABSTRACT

A biaxially oriented polypropylene film having a 1% secant modulus of from 500 MPa to 5000 MPa and a shrinkage greater than or equal to 9%. A method of producing a biaxially oriented film comprising providing a metallocene catalyzed polypropylene homopolymer, casting said polypropylene homopolymer into a film, stretching said film on a batch line, at a temperature of 120° C. to 140° C. or stretching said film in the machine direction on a continuous line at a temperature of from 90° C. to 160° C., and stretching said film in the transverse direction on a continuous line at a temperature of from 130° C. to 180° C.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present disclosure relates generally to the production of polypropylene materials and more specifically to the production of oriented polypropylene film having a desirable combination of modulus and shrinkage.

2. Background of the Invention

Synthetic polymeric materials, particularly polypropylene resins, are widely used in the manufacturing of a variety of end-use articles ranging from medical devices to food containers. Commercial grade polypropylenes are typically produced using either a Ziegler-Natta or metallocene catalyst mechanism in a polymerization process. Many industries, such as the packaging industry, utilize these polypropylene materials in various manufacturing processes to create a variety of finished goods.

Within the packaging industry, there are a number of unique applications that ideally require either stiff materials or materials having a high degree of shrinkage. Herein shrinkage refers to the volume difference between the initially formed and final formed article and is expressed in terms of percent change while the ductility of the material is expressed in terms of the secant modulus. A material having the combination of high shrinkage and high stiffness may be desirable for applications such as shrink-wrap where the material that is used to encase an object is subsequently heated and shrinks to wrap securely around said object. However, high shrinkage often correlates with a fairly ductile material having a low value for the secant modulus. Therefore, a need exists for a material having both high shrinkage and high stiffness.

### BRIEF SUMMARY OF SOME OF THE PREFERRED EMBODIMENTS

Disclosed herein is a biaxially oriented polypropylene film having a 1% secant modulus of from 500 MPa to 5000 MPa and a shrinkage greater than or equal to 9%.

Also disclosed herein is a method of producing a biaxially oriented film comprising providing a metallocene catalyzed polypropylene homopolymer, casting said polypropylene homopolymer into a film, stretching said film on a batch line, at a temperature of 120° C. to 140° C. or stretching said film in the machine direction on a continuous line at a temperature of from 90° C. to 160° C., and stretching said film in the transverse direction on a continuous line at a temperature of from 130° C. to 180° C.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 is a schematic illustration of a tenter frame orientation process.

FIG. 2 is a plot of secant modulus as a function of percent xylene solubles for the compositions of Example 1.

FIG. 3 is a plot of shrinkage as a function of percent xylene solubles for the compositions of Example 1.

### DETAILED DESCRIPTION OF THE PREFERRED EMBODIMENTS

Disclosed herein are polymeric compositions comprising a metallocene-catalyzed polymer of propylene (mPP). Said compositions may be used to form an oriented film by processes to be described in detail later herein. The films of this disclosure may display desirable physical properties such as an increased shrinkage and increased stiffness when compared to existing polypropylene films.

In an embodiment, the polymeric composition comprises a mPP. The mPP may be a homopolymer or a copolymer, for example a copolymer of propylene with one or more alpha olefin monomers such as ethylene, butene, hexene, etc. In an embodiment, the mPP is a polypropylene homopolymer provided however that the homopolymer may contain up to about 5% of another alpha-olefin, including but not limited to C₂-C₈ alpha-olefins such as ethylene and 1-butene. Despite the potential presence of small amounts of other alpha-olefins, the mPP is generally referred to as a polypropylene homopolymer. In an embodiment, the homopolymer mPP contains less than 2 wt. % ethylene, in another embodiment less than 1 wt. % ethylene, and in a further embodiment less than 0.5 wt. % ethylene. An example of a suitable mPP includes without limitation a propylene homopolymer sold as Total Petrochemicals M3282MZ by Total Petrochemicals USA, Inc. In an embodiment, the mPP (e.g., M3282MZ) has the physical properties set forth in Table 1.

TABLE 1

| | | ASTM |
|---|---|---|
| | Typical Value | Method |
| Resin Properties⁽¹⁾ | | |
| Melt Flow, g/10 min. | 2.3 | D 1238 Condition “L” |
| Density, g/cc | 0.905 | D 1505 |
| Melting Point, ° F. (° C.) | 307 (153) | DSC⁽²⁾ |
| Mechanical Properties⁽¹⁾ | | |
| Tensile, psi (M Pa) | 4,900 (33.8) | D 638 |
| Elongation, % | >72 | D 638 |
| Flexural Modulus, psi (M Pa) | 216,000 (1,490) | D 790 |
| Izod Impact @ 73° F. | | D 256A |
| Notched-ft.lb./in. (J/m) | 1.3 (65) | |
| Thermal Properties⁽¹⁾3 | | |
| Heat Deflection | | D 648 |
| ° F. at 66 psi | 207 | |
| ° C. at 4.64 kg/cm² | 97 | |

⁽¹⁾Data developed under laboratory conditions and are not to be used as specification, maxima or minima.
⁽²⁾MP determined with a DSC-2 Differential Scanning Calorimeter.

Homopolymer mPP may be formed by placing propylene alone in a suitable reaction vessel in the presence of a metallocene catalyst and under suitable reaction conditions for polymerization thereof. Using a metallocene catalyst to form the homopolymer may allow for better control of the crystalline structure of the homopolymer due to its isotactic tendency to arrange the attaching molecules. The metallocene catalyst ensures that a majority of the propylene monomer is attached so that the pendant methane groups (—CH₃) line up in an isotactic orientation (i.e., on the same side) relative to the backbone of the molecule.

Standard equipment and processes for polymerizing the propylene into a homopolymer are known to one skilled in the art. Such processes may include solution phase, gas phase, slurry phase, bulk phase, high pressure processes or combinations thereof, for example. Such processes are described in detail in U.S. Pat. Nos. 5,525,678, 6,420,580, 6,380,328, 6,359,072, 6,346,586, 6,340,730, 6,339,134, 6,300,436, 6,274,684, 6,271,323, 6,248,845, 6,245,868, 6,245,705, 6,242,545, 6,211,105, 6,207,606, 6,180,735 and 6,147,173, which are incorporated herein by reference in their entirety.

In certain embodiments, the processes described above generally include polymerizing olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. The formed polymer may include homopolymers, copolymers or terpolymers, for example. Examples of solution processes are described in U.S. Pat. Nos. 4,271,060, 5,001,205, 5,236,998 and 5,589,555, which are incorporated herein by reference in their entirety.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. Nos. 4,543,399, 4,588,790, 5,028,670, 5,317,036, 5,352,749, 5,405,922, 5,436,304, 5,456,471, 5,462,999, 5,616,661, 5,627,242, 5,665,818, 5,677,375 and 5,668,228, which are incorporated herein by reference in their entirety.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutene), for example. The medium employed is generally liquid under the conditions of polymerization and relatively inert. A bulk phase process is similar to that of a slurry process. However, a process may be a bulk process, a slurry process or a bulk slurry process, for example.

Polypropylene homopolymers or copolymers may be produced using metallocene catalysts under various conditions in polymerization reactors which may be batch type reactors or continuous reactors. Continuous polymerization reactors typically take the form of loop-type reactors in which the monomer stream is continuously introduced and a polymer product is continuously withdrawn. For example, polymers such as polypropylene, or ethylene-propylene copolymers involve the introduction of the monomer stream into the continuous loop-type reactor along with an appropriate catalyst system to produce the desired olefin homopolymer or copolymer. The resulting polymer is withdrawn from the loop-type reactor in the form of a “fluff” which is then processed to produce the polymer as a raw material in particulate form as pellets or granules.

Homopolymer mPP may be prepared through the use of metallocene catalysts of the type disclosed and described in further detail in U.S. Pat. Nos. 5,158,920, 5,416,228, 5,789,502, 5,807,800, 5,968,864, 6,225,251, 6,777,366, 6,777,367, 6,579,962, 6,468,936, 6,579,962 and 6,432,860, each of which is incorporated herein by reference in its entirety. Catalysts that produce isotactic polyolefins are disclosed in U.S. Pat. Nos. 4,794,096 and 4,975,403. In an embodiment, a suitable metallocene catalyzed polypropylene comprises an isotactic polypropylene prepared by the polymerization of propylene in the presence of a metallocene catalyst characterized by the formula:
rac-R′R″Si(2-RᵢInd)MeQ₂
In the formula above, R′, R″ are each independently a C₁-C₄ alkyl group or an phenyl group; Ind is an indenyl group substituted at the proximal position by the substituent R.sub.s and otherwise unsubstituted; Rᵢ is an ethyl, methyl, isopropyl, or tertiary butyl group; Me is a transition metal selected from the group consisting of titanium, zirconium, hafnium, and vanadium; and each Q is independently a hydrocarbyl group or containing 1 to 4 carbon atoms or a halogen.

In an alternative embodiment, a suitable metallocene catalyst is one that may produce isotactic polyolefins as disclosed in U.S. Pat. Nos. 4,794,096 and 4,975,403 which are incorporated by reference herein in its entirety. Said catalysts may be chiral, stereorigid metallocene catalysts that polymerize olefins to form isotactic polymers and are especially useful in the polymerization of highly isotactic polypropylene. The stereorigidity in a metallocene ligand may be imparted by means of a structural bridge extending between cyclopentadienyl groups. In an embodiment, the catalysts are stereoregular hafnium metallocenes which may be characterized by the following formula:
R″(C₅R′)₂HfQₚ
where (C₅R′) is a cyclopentadienyl or substituted cyclopentadienyl group, R′ is independently hydrogen or a hydrocarbyl radical having 1-20 carbon atoms, and R″ is a structural bridge extending between the cyclopentadienyl rings. Q is a halogen or a hydrocarbon radical, such as an alkyl, aryl, alkenyl, alkylaryl, or arylalkyl, having 1-20 carbon atoms and p is 2. In an embodiment, the homopolymer mPP may have a melt flow rate (MFR) of less than or equal to 12 g/10 min., alternatively less than or equal to 6 g/10 min., alternatively from 0.5 g/10 min. to 6 g/10 min. MFR as defined herein refers to the quantity of a melted polymer resin that will flow through an orifice at a specified temperature and under a specified load. The MFR may be determined using a dead-weight piston plastometer that extrudes polypropylene through an orifice of specified dimensions at a temperature of 230° C. and a load of 2.16 kg in accordance with ASTM Standard Test Method D-1238.

In the preparation of a homopolymer mPP, a certain amount of amorphous or atactic polymer is produced. This amorphous or atactic PP is soluble in xylene and is thus termed the xylene soluble fraction (XS %). In determining XS %, the polymer is dissolved in boiling xylene and then the solution cooled to 0° C. which results in the precipitation of the isotactic or crystalline portion of the polymer. The XS % is that portion of the original amount that remained soluble in the cold xylene. Consequently, the XS % in the polymer is indicative of the extent of crystalline polymer formed. The total amount of polymer (100%) is the sum of the xylene soluble fraction and the xylene insoluble fraction. In an embodiment, the homopolymer mPP has a xylene soluble fraction of less than 1%, in another embodiment less than 0.9%, in an additional embodiment less than 0.8%, in still another embodiment less than 0.7%, in a further embodiment less than 0.6%, in still another embodiment less than 0.5%, in another embodiment less than 0.4%, in another embodiment less than 0.3%, in another embodiment less than 0.2%, in an additional embodiment less than 0.1%. Methods for determination of the XS % are known in the art, for example the XS % may be determined in accordance with ASTM D 5492-98.

In an embodiment, the homopolymer mPP may have a melting point range of from 130° C. to 170° C.; alternatively from 140° C. to 160° C., alternatively from 145° C. to 155° C. The melting point range is also indicative of the degree of crystallinity of the polymer.

In an embodiment, the homopolymer mPP may also contain additives to impart desired physical properties, such as printability, increased gloss or a reduced blocking tendency. Examples of additives include without limitation stabilizers, ultra-violet screening agents, oxidants, anti-oxidants, anti-static agents, ultraviolet light absorbents, fire retardants, processing oils, mold release agents, coloring agents, pigments/dyes, fillers, and/or other additives known to one skilled in the art with or without other components. The aforementioned additives may be used either singularly or in combination to form various formulations of the polymer. For example, stabilizers or stabilization agents may be employed to help protect the polymer resin from degradation due to exposure to excessive temperatures and/or ultraviolet light. These additives may be included in amounts effective to impart the desired properties. Effective additive amounts and processes for inclusion of these additives to polymeric compositions are known to one skilled in the art.

The polymeric compositions of this disclosure may be converted to end-use articles by any suitable method. In an embodiment, this conversion is a plastics shaping process such as known to one of ordinary skill in the art. Examples of end use articles into which the polymeric composition may be formed include pipes, films, bottles, fibers, containers, cups, lids, plates, trays, car parts, blister packs, and so forth. Additional end use articles would be apparent to those skilled in the art.

In an embodiment, the end-use article is a film, which may be further formed into a packaging container for a consumer product. Said films may be used as shrink-wrap wherein the film is used to encase a product and is subsequently heated to a temperature range of 115° C. to 182° C., alternatively to a temperature range of 124° C. to 166° C. The temperature range to which the film is heated may also be dependent on the type of equipment used to heat the film and such ranges and equipment may be chosen to meet the requirements of the film and user by one of ordinary skill in the art. Following heating, the film may shrink to wrap securely around said object and may form a container for said product. The films of this disclosure may be produced by any method and under any conditions known to one skilled in the art for the production of films. In an embodiment, the polymeric compositions are formed into films by the process described herein.

In an embodiment, the polymeric compositions of this disclosure are formed into a film. The film may be produced by a cast extrusion process wherein the molten polymer is extruded through a slot or die to form a thin, extruded sheet (typically having a thickness greater than 10 mils) or film (typically having a thickness equal to or less than 10 mils). The extruded sheet or film is then adhered to a cooled surface, such as a chill roll that may be in contact with a water bath. The chill roll functions to immediately quench the sheet or film. The sheet or film may then be passed through rollers designed to stretch the sheet in differing axial directions to produce biaxially oriented films, which may be further trimmed and rolled for transport or storage. The extent of stretching is reported in terms of draw ratios which refer to the extent of stretching in the x versus y direction of the film. For example a draw ratio of 4:1 in the x-direction indicates the film was stretched 4 times its original length in the x-direction. In an embodiment, the homopolymer mPP is oriented 4:1 in the machine direction, alternatively 5:1 in the machine direction, alternatively 6:1 in the machine direction (MD) and 5:1 in the transverse direction, alternatively, 6:1 in the transverse direction, alternatively 10:1 in the transverse direction (TD). Overall, after the two-dimensional stretching, the thickness of the original resin is reduced 40:1.

In one embodiment, the sheet casting and stretching are two discrete steps as a batch process. Sheet can be stretched in a batch stretcher such as for example and without limitation KARO TV Laboratory Stretcher (Bruckner, Siegsdorf, Germany). The homopolymer mPP may be stretched in an oven operating in a temperature range of 120° C. to 140° C., alternatively 120° C. to 135° C., alternatively 125° C. to 135° C. The homopolymer may be stretched using a stretching speed of 1 m/min to 10 m/min, alternatively 10 m/min to 20 m/min, alternatively 20 m/min to 30 m/min. In an embodiment the homopolymer mPP is extruded into a film which is biaxially oriented to form biaxially oriented polypropylene (BOPP).

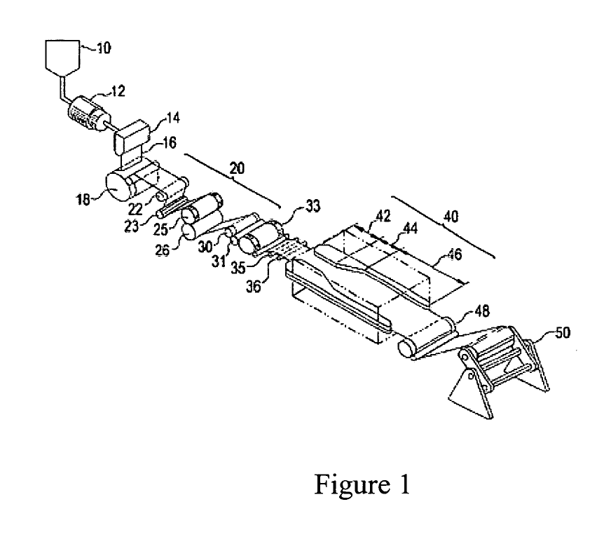

In another embodiment, the sheet casting and stretching may form a continuous process. Turning now to FIG. 1, there is shown a schematic illustration of a suitable continuous “Tenter Frame” orientation process which may be employed in producing biaxially oriented polypropylene film in accordance with the present disclosure. With reference to FIG. 1, a source of molten polymer is supplied from a hopper 10 to an extruder 12 and from there to a slot die 14 which produces a flat, relatively thick film 16 at its output. Film 16 is applied over a chill roller 18, and it is cooled to a suitable temperature within the range of 30° C. to 60° C. The film is drawn off the chill roller 18 to a stretching section 20 to which the machine direction orientation occurs by means of idler rollers 22 and 23 which lead to preheat rollers 25 and 26.

As the film is drawn off the chill roller 18 and passed over the idler rollers, it is cooled to a temperature within the range of 30° C. to 60° C. In stretching the film in the machine direction, it is heated by preheat rollers 25 and 26 to an incremental temperature increase in the range of 60° C. to 100° C. and then passed to the slow roller 30 of the longitudinal orienting mechanism. The slow roller may be operated at any suitable speed, usually about 20-40 feet per minute. The fast roller 31 is operated at a suitable speed, typically about 150 feet per minute, to provide a surface speed at the circumference of about 4-7 times that of the slow roller in order to orient the film in the machine direction. As the oriented film is withdrawn from the fast roller, it is passed over roller 33 at room temperature conditions. From here it is passed over tandem idler rollers 35 and 36 to a lateral stretching section 40 where the film is oriented by stretching in the transverse direction. The section 40 includes a preheat section 42 comprising a plurality of tandem heating rollers (not shown) where it is again reheated to a temperature within the range of 130° C. to 180° C. From the preheat section 42 of the tenter frame, the film is passed to a stretching or draw section 44 where it is progressively stretched by means of tenter clips (not shown) which grasp the opposed sides of the film and progressively stretch it laterally until it reaches it maximum lateral dimension. Lateral stretching ratios are typically greater than machine direction stretch ratios and often may range from 5-12 times the original width. Lateral stretching ratios of 8-10 times are usually preferred. The concluding portion of the lateral stretching phase includes an annealing section 46, such as an oven housing, where the film is heated at a temperature within the range of 130° C. to 170° C. for a suitable period of time, about 1-10 seconds. The annealing time helps control certain properties, and increased annealing can be used specifically to reduce shrinkage. The biaxially-oriented film is then withdrawn from the tenter frame and passed over a chill roller 48 where it is reduced to a temperature of less than 50° C. and then applied to take-up spools on a take-up mechanism 50. From the foregoing description, it will be recognized that the initial orientation in the machine direction is carried out at a somewhat lower temperature than the orientation in the lateral dimension. For example, the film exiting the preheat rollers is stretched in the machine direction at a temperature of 120° C. The film may be cooled to a temperature of 50° C. and thereafter heated to a temperature of about 160° C. before it is subject to the progressive lateral dimension orientation in the tenter section. Processes and equipment to orient films are described in more detail in U.S. Pat. Nos. 6,995,213 and 6,579,962, each of which is incorporated herein by reference in its entirety.

The homopolymer mPP compositions disclosed herein and end-use articles constructed there from may display an improved stiffness as determined by an increase in the 1% secant modulus. The secant modulus is a measure of the stress to strain response of a material or the ability to withstand deformation under an applied force. In an embodiment, the homopolymer mPP compositions disclosed herein and end-use articles constructed there from have a 1% secant modulus of from 500 MPa to 5000 MPa, alternatively from 1000 MPa to 4000 MPa, alternatively, from 1500 MPa to 3500 MPa as determined in accordance with a modified ASTM D-882.

In an embodiment, the homopolymer mPP compositions disclosed herein and end-use articles formed there from have a shrinkage of equal to or greater than 9%, in another embodiment equal to or greater than 10%, in still another embodiment equal to or greater than 11%, in an additional embodiment equal to or greater than 12%, in a further embodiment equal to or greater than 13%, and in yet another embodiment equal to or greater than 14%. Shrinkage may be calculated by first measuring the length of contraction upon cooling in the in-flow (machine) direction and the length of contraction occurring in the cross-flow (transverse) direction. The difference in the in-flow and cross-flow contractions multiplied by 100% gives the percent shrinkage. Typical measurements of shrinkage are limited to measuring the changes in the direction of resin flow and in a direction perpendicular to the direction of resin flow.

In an embodiment, film shrinkage is measured by using procedure where the film is heated at 125° C. (±1° C.) for three minutes in a convection oven. Specimens are to be taken from the center of each BOPP film and a square inked stamp with dimensions of 100×100 mm is applied on the center of each BOPP film (the machine direction (MD) will be marked by the stamp template). Each specimen is placed on heavy paper that has been lightly dusted with talc. The film is then covered with a second paper and the two papers are fastened together so the film is in the center. The paper-film-paper “sandwich” is placed horizontally in the 125° C. oven for three minutes. After three minutes, the sandwich is removed and cooled to room temperature. The stamped dimensions are measured after cooling. The percent change in sample dimensions is the shrinkage.

In an embodiment, the homopolymer mPP when formed into a film as disclosed herein has a 1% secant modulus of from 500 MPa to 5000 MPa and a shrinkage of equal to or greater than 9%. In an embodiment, the homopolymer mPP is substantially free of processing additives designed to enhance shrinkage, alternatively the homopolymer mPP comprises less than 5 wt. % of process additives designed to enhance shrinkage, alternatively less than 4 wt. %, alternatively less than 3 wt. %, alternatively less than 2 wt. % alternatively less than 1 wt. %, alternatively less than 0.5 wt. %, alternatively less than 0.1 wt. %. Such processing additives are known to one of ordinary skill in the art and include for example and without limitation hydrocarbon resins. Hydrocarbon resins are derived from hydrocarbon feedstock from the petrochemical industry, and resins based on natural raw materials from trees called crude tall oil and gum rosin. Examples of such hydrocarbon resins include with out limitation OPPERA™ Polymer Additives a hydrocarbon resin commercially available from Exxon Mobil and REGALITE hydrocarbon resins, which are hydrogenated hydrocarbon resins commercially available from Eastman Chemical Company. Other hydrocarbon processing additives as known to one of ordinary skill in the art can also be used.

### EXAMPLES

The invention having been generally described, the following examples are given as particular embodiments of the invention and to demonstrate the practice and advantages thereof. It is understood that the examples are given by way of illustration and are not intended to limit the specification of the claims in any manner.

### Example 1

Five polypropylene homopolymer compositions were prepared by slurry-loop reactor polymerization of propylene as previously described. These homopolymers were cast into 16 mil (406 μm) sheets. Four of the polypropylene homopolymer compositions (ZN1-1, ZN1-2, ZN1-3, ZN1-4) were prepared using a Ziegler Natta catalyst while M1-1 is a polypropylene homopolymer prepared using a metallocene catalyst. The ZN1-1 propylene homopolymer is similar to Total Petrochemicals 3270 homopolymer high crystallinity low melt flow film grade, the ZN1-2 propylene homopolymer is similar to Total Petrochemicals 3365 homopolymer extrusion grade for water quench slit film, the ZN1-3 and ZN1-4 propylene homopolymer is similar to Total Petrochemicals 3371 homopolymer film grade and M1-1 propylene homopolymer is similar to Total Petrochemicals M3282MZ homopolymer clarified metallocene sheet extrusion and thermoforming grade all of which are propylene homopolymers commercially available from Total Petrochemicals USA, Inc. Physical properties for all of the commercially available resins are given in Tables 2a-d. The melting point for each of the resins was determined by differential scanning calorimetry using a modified version of ASTM D 3418-99. Specifically, for a sample weighing between 5 and 10 g, the following standard test conditions involved heating the sample from 50° C. to 210° C. to erase the thermal history of the sample, followed by holding the sample at 210° C. for 5 minutes. The sample is then cooled to 50° C. to induce recrystallization and subsequently subjected to a second melt in the temperature range 50° C. to 190° C. For each of these temperature changes, the temperature is ramped at a rate of 10° C./min.

TABLE 2a-3270

| | | ASTM |
|---|---|---|
| | Typical Value | Method |
| Resin Properties ⁽¹⁾ | | |
| Melt Flow, g/10 min. | 2.0 | D-1238 230° |
| | | C./2180 g |
| Density, g/cc | 0.91 | D-1505 |
| Melting Point, ° F., (° C.) | 329 (165) | DSC ⁽²⁾ |
| Film Properties, Oriented ⁽¹⁾⁽³⁾ | | |
| Haze, % | 1.0 | D-1003 |
| Gloss, 45°, % | 85 | D-2457 |
| Ultimate Tensile, psi MD (psi TD) | 28,000 (39,000) | D-882 |
| Tensile Modulus, psi MD (psi TD) | 420,000 (700,000) | D-882 |
| Elongation, % MD (TD) | 150 (60) | D-882 |
| WVTR, g/100 sq-in/24 hrs/mil @ | 0.2 | F-1249-90 |
| 100° F., 90% relative humidity | | |

⁽¹⁾ Data developed under laboratory conditions and not to be used as specification of maxima or minima.
⁽²⁾ MP determined with a Differential scanning calorimeter.
⁽³⁾ Tenter-frame oriented film

TABLE 2b-3365

| | | ASTM |
|---|---|---|
| | Typical Value | Method |
| Resin Properties ⁽¹⁾ | | |
| Melt Flow, g/10 min. | 3.8 | D-1238 Condition “L” |
| Density, g/cc | 0.905 | D-1505 |
| Melting Point, ° F., (° C.) | 330 (165) | DSC ⁽²⁾ |
| Mechanical Properties, ⁽¹⁾ | | |
| Tensile Modulus, psi (M Pa) | 220,000 (1,515) | D-638 |
| Flexural Modulus psi (M Pa) | 200,000 (1,380) | D-790 |
| Flexural Stiffness | 160,000 (1,104) | D-790 |
| Fiber Properties ⁽¹⁾⁽³⁾ | | |
| Tenacity g/denier | 5.8 | |
| Elongation % | 28 | |

⁽¹⁾ Data developed under laboratory conditions and not to be used as specification of maxima or minima.
⁽²⁾ MP determined with a Differential scanning calorimeter.
⁽³⁾ Samples processed at 6:1 ratio and 450 degrees H (232 degrees C.) melt temperature.

TABL 2c-3371E

| | | ASTM |
|---|---|---|
| | Typical Value | Method |
| Resin Properties ⁽¹⁾ | | |
| Melt Flow, g/10 min. | 2.8 | D-1238 230° |
| | | C./2180 g |
| Density, g/cc | 0.91 | D-1505 |
| Melting Point, ° F., (° C.) | 325 (163) | DSC ⁽²⁾ |
| Film Properties, Oriented ⁽¹⁾⁽³⁾ | | |
| Haze, % | 1.0 | D-1003 |
| Gloss, 45°, % | 90 | D-2457 |
| Ultimate Tensile, psi MD (psi TD) | 19,000 (38,000) | D-882 |
| Tensile Modulus, psi MD (psi TD) | 350,000 (600,000) | D-882 |
| Elongation, % MD (TD) | 130 (50) | D-882 |
| WVTR, g/100 sq-in/24 hrs/mil @ | 0.3 | F-1249-90 |
| 100° F., 90% relative humidity | | |

⁽¹⁾ Data developed under laboratory conditions and not to be used as specification of maxima or minima.
⁽²⁾ MP determined with a Differential scanning calorimeter.
⁽³⁾ Tenter-frame oriented film

TABL 2d-M3282MZE

| | | ASTM |
|---|---|---|
| | Typical Value | Method |
| Resin Properties ⁽¹⁾ | | |
| Melt Flow, g/10 min. | 2.3 | D-1238 Condition “L” |
| Density, g/cc | 0.905 | D-1505 |
| Melting Point, ° F., (° C.) | 307 (153) | DSC ⁽²⁾ |
| Mechanical Properties, ⁽¹⁾ | | |
| Tensile psi (M Pa) | 4,900 (33.8) | D-638 |
| Elongation % | >72 | D-638 |
| Flexural Modulus psi (M Pa) | 216,000 (1,490) | D-790 |
| Izod Impact @ 73° F. | 1.3 (65) | D-256A |
| Notched-ft-lb/in (J/m) | | |
| Thermal Properties ⁽¹⁾ | | |
| Heat Deflection | | D-648 |
| ° F. at 66 psi | 207 | |
| ° C. at 4.64 kg/cm² | 97 | |

⁽¹⁾ Data developed under laboratory conditions and not to be used as specification of maxima or minima.
⁽²⁾ MP determined with a Differential scanning calorimeter.

The MFR, XS % and melting temperature for each polypropylene homopolymer composition used in this study were determined in accordance with the previously referenced ASTM procedures and are presented in Table 3.

TABLE 3

| | Melt Flow Rate | Xylene Solubles | Melting Temperature |
|---|---|---|---|
| Material | (dd/min) | (%) | (° C.) |
| ZN1-1 | 1.9 | 0.79 | 166.4 |
| ZN1-2 | 3.7 | 2.02 | 161.7 |
| ZN1-3 | 2.7 | 3.21 | 162.0 |
| ZN1-4 | 2.8 | 4.15 | 161.4 |
| M1-1 | 3.9 | 0.23 | 153.8 |

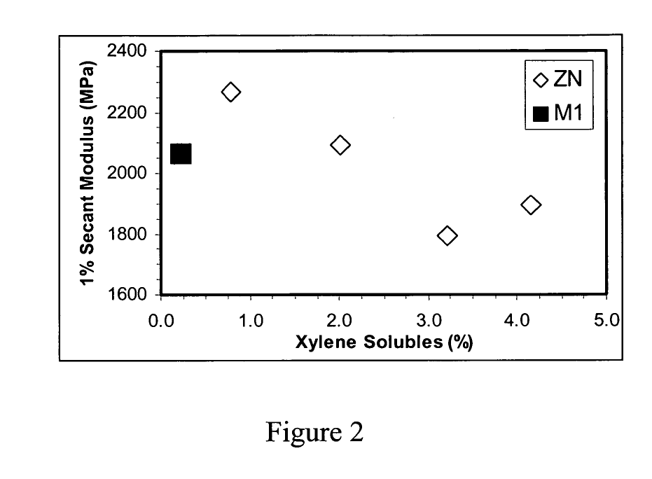

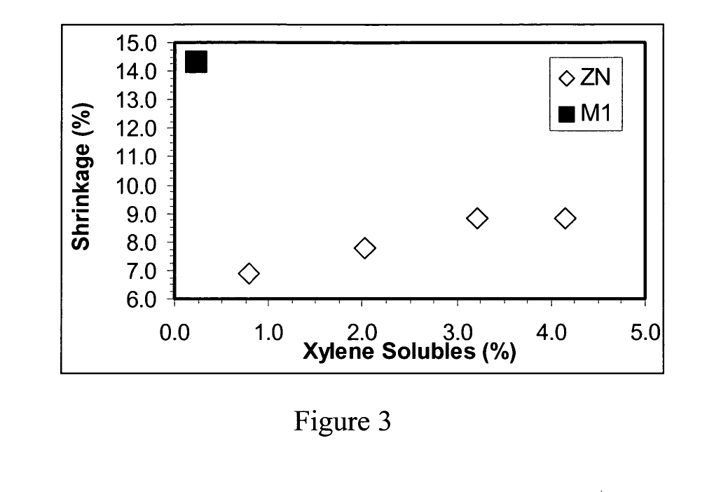

The five homopolymer sheets were then stretched at 135° C. at a 6×6 draw ratio. The stretching speed was 30 m/min. The 1% secant modulus for each homopolymer composition was determined in accordance with ASTM D-882 and plotted as a function of the XS % in FIG. 2. The percent shrinkage of each homopolymer composition was determined by heating a 100 mm×100 mm square of the film at 125° C. for three minutes and then measuring the dimensional changes as described previously herein. The percent shrinkage as a function of XS % are plotted in FIG. 3. The results demonstrate the metallocene catalyzed polypropylene homopolymer resins had much greater shrinkage than any of the homopolymer polypropylene resins prepared with the Ziegler-Natta catalysts. Thus, the metallocene catalyzed polypropylene homopolymer resins displays a desirable combination of high 1% secant modulus in the range of from 500 MPa to 5000 MPa and shrinkage greater than 9%.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A biaxially oriented polypropylene film having a 1% secant modulus of from 500 MPa to 5000 MPa and a shrinkage greater than or equal to 9%.

2. The film of claim 1 wherein the polypropylene is produced using a metallocene catalyst.

3. The film of claim 1 wherein the polypropylene is a homopolymer.

4. The film of claim 3 further comprising ethylene.

5. The film of claim 4 wherein the ethylene is present in an amount of less than 2 wt. %.

6. The film of claim 3 wherein a xylene solubles content of the polypropylene is less than 1%.

7. The film of claim 3 wherein a melt flow rate of the polypropylene is equal to or less than 12 g/10 min.

9. The film of claim 3 wherein a melting point of the polypropylene is from 130° C. to 170° C.

10. The film of claim 1 comprising less than about 5 wt % of one or more process additives designed to enhance shrinkage.

11. The film of claim 10 wherein the process additives designed to enhance shrinkage are hydrocarbon resins.

12. An article formed from the film of claim 1.

13. A method of producing a biaxially oriented film comprising:
(a) providing a metallocene catalyzed polypropylene homopolymer;
(b) casting said polypropylene homopolymer into a film;
(c) stretching said film on a batch line, at a temperature of 120° C. to 140° C. or stretching said film in the machine direction on a continuous line at a temperature of from 90° C. to 160° C.; and
(d) stretching said film in the transverse direction on a continuous line at a temperature of from 130° C. to 180° C.

14. The method of claim 13 wherein the film has a 1% secant modulus of equal to or greater than 2000 MPa.

15. The method of claim 13 wherein the film has a shrinkage of equal to or greater than 9%.

16. The method of claim 13 wherein a xylene solubles content of the polypropylene is less than 1%.

17. The method of claim 13 wherein a melt flow rate of the polypropylene is equal to or less than 12 g/10 min.

18. The method of claim 13 wherein a melting point of the polypropylene is from 145° C. to 155° C.

19. An article prepared by the method of claim 13.

20. The article of claim 19 comprising a packaging container for a consumer product.
